(19) United States
(12) Patent Application Publication
(10) Pub. No.: US 2024/0053600 A1
(43) Pub. Date: Feb. 15, 2024

(54) SPACE-BORNE IMAGING SYSTEM

(71) Applicant: IGOR ABRAMOV, VISTA, CA (US)

(72) Inventor: IGOR ABRAMOV, VISTA, CA (US)

(21) Appl. No.: 17/884,569

(22) Filed: Aug. 10, 2022

(51) Int. Cl. G02B 26/08; G02B 7/183; G02B 27/00

(52) U.S. Cl. CPC G02B 26/0825; G02B 7/183; G02B 27/0068

(57) ABSTRACT

A space-borne imaging system with a paraboloid mirror fabricated in space is described. The mirror is formed by solidifying liquid precursor material after its surface assumes a paraboloid shape as a result of compound rotation of the satellite. The mirror is preferably formed from a photopolymer which creates a rigid paraboloid mirror surface upon exposure to a cross-linking radiation source. Optical coating(s) deposition system is described as well. Several deployable satellite structures, including mirror support are executed in shape memory materials and are deployed by application of heat. Mirror material support is executed as a pliable membrane compactly stowable for launch. Prior to mirror generation the support is optionally stiffened by crosslinking an impregnating it polymer or depositing a base layer of polymer ahead of the main polymer charge.

### CROSS-REFERENCE TO RELATED APPLICATION

This is a continuation-in-part of application Ser. No. 17/493,396 filed on 2021 Oct. 4 titled “Imaging Satellite” which is incorporated herein in its entirety by reference and claims priority benefits thereof.

### FIELD OF INVENTION

This invention relates in general to space imaging systems and in particular to space-borne telescopes and small- and ‘cube’-satellites with imaging capabilities.

### BACKGROUND OF INVENTION

At present, space-borne systems, such as satellites equipped with high resolution imaging systems and space-borne telescopes such as Hubble (with 2.4-meter diameter mirror) and James Webb (with 6.5-meter diameter compound mirror), are quite large in order to accommodate large optical structures required for high resolution imaging. A traditional space-borne imaging system is based on a reflective-type telescope which contains a relatively large primary mirror.

This mirror is customarily made of a single piece of highly polished glass or other stable materials such as beryllium or silicon carbide. The mirror has to be mechanically securely supported during launch to prevent damage to itself as well as potential damage to the satellite or the launch vehicle. The mirror support(s) introduce considerable added weight and bulk to the overall satellite imaging system, complicating its packaging for launch, increasing launch costs and limiting selection of launch vehicles.

Additionally, space-borne telescopes with very large aperture, such as Webb, use several mirror elements precisely assembled/deployed into a single reflecting structure while in space. The mechanical precision and stability of this structure is extraordinary, since this it has to behave like a single-piece mirror. These requirements put exceptional demands on the mirror support and deployment structures, both to survive the launch stresses and to ensure reliable and precise deployment and positioning of the individual mirror elements into a monolithic reflecting structure.

Recent adoption and proliferation of miniature so called ‘cube’-, ‘nano’- and ‘small’-satellites (collectively called ‘cube-sats’) introduced a new paradigm to space exploration and utilization. However, the cube-sats at present lack high-resolution imaging capabilities, since they cannot accommodate large telescope primary mirrors required for such imaging.

Yet, such a capability would greatly enhance the utility of cube-sats and put their performance close to-, or even on-par with the large space telescopes currently deployed.

In addition, the disclosed invention enables making mirrors in space of large, and very large diameters: in the order of tens of meters.

### OBJECTIVES OF THE INVENTION

Thus, it is the objective of instant invention to provide a relatively large imaging mirror on a miniature cube-sat to enhance its imaging capability.

Another objective is to provide an imaging mirror which would not require complex and heavy structural supports during the launch of the satellite or a space-borne telescope.

Another objective is to provide an imaging mirror which would be formed in space.

Yet another objective is to provide an imaging mirror which would be formed as a single piece.

Another objective is to provide an imaging mirror which would be lightweight.

Yet another objective is to provide an imaging mirror which would be repairable in orbit, without additional instruments.

Another objective is to provide space-born structures which would form imaging mirrors in space.

### SUMMARY OF THE INVENTION

In accordance with the present invention, described is a structure notionally based on a cube-sat platform, hereinafter interchangeably referred to as a ‘platform’, a ‘satellite’ or a ‘structure’, with an imaging mirror being formed in space. Also, hereinafter the term ‘UV’ shall mean ‘Ultra-Violet’, as in ‘ultra-violet light’.

The mirror paraboloid shape is formed by a liquid photopolymer or other liquid precursors which assume paraboloid shape upon certain rotational maneuvers of the platform itself, to subsequently harden into a solid paraboloid mirror shape.

When a photopolymer is used for mirror material it is subsequently solidified via crosslinking by exposing it to UV illumination supplied by the system's light source(s).

If an alternative liquid precursor, such as molten metal, thermoset- and thermoplastic polymers, or two-part epoxy is used, it is allowed to cool and solidify prior to cessation of satellite movement to create the mirror.

Shape-memory materials are used extensively in proposed systems for deploying and positioning mirror supports as well as the completed mirror in its operational position on the structure.

The mirror support is made from a pliable material which can be efficiently folded prior to deployment. Along its periphery it is connected to a shape-memory deployable circular support hoop.

Both mirror support and its support hoop remain in their compact stowed configuration until deployment.

For deployment the support hoop is heated to- or above the phase- or glass transition temperature of its shape-memory material and assumes its previously ‘trained’ circular shape, and in turn stretches the pliable mirror support into a generally disk-shaped form.

The heating of the deployable elements is provided preferably by heating them with an electric current passed directly through them. Alternatively, such as in emergency, elements' heating can be accomplished by exposure to sunlight.

In the next step, the structure is spun simultaneously around two orthogonal axes: one to generate an artificial gravity and another to provide radial acceleration to the mirror support, while a liquid mirror precursor is deposited onto it.

As a result of this compound rotation, the liquid precursor assumes a paraboloid shape. It is then either allowed to cool/solidify (in case of molten materials or mixed epoxies), or crosslinked with a UV light (in case of photopolymers).

Afterwards, thusly formed paraboloid surface can be either left as-is (in case of solidified metals), or coated with reflective materials such as metals, or multi-layer reflecting coatings. For the latter, a coating system is included in the structure.

Since the mirror support material is pliable, depending on the characteristics of a particular support material used, steps prior to the mirror generation may be taken to stiffen and stabilize it, by using several techniques described hereinafter.

After stiffening of the mirror support material, the mirror generation proceeds as described above.

Upon completion of mirror generation an extendable boom erects the mirror and the imaging system into their operating position and attitude with respect to the satellite's body, to ensure mirror's clear field of view. Several deployable boom embodiments are presented, all of which rely on the shape-memory materials for their deployment.

Articles made with shape-memory materials, their fabrication, shape ‘training’ and usage are known in their respective arts.

A structure or a satellite equipped with such an imaging mirror can be thought of a type of ‘smart’ space-based telescope.

### PRIOR ART

It has been known since 1600's that a surface of liquid spun around a vertical axis assumes a paraboloid shape. On the surface of the Earth paraboloid telescope mirrors created with spinning layer of liquid mercury have also been known for some time. Indeed, relatively recent NASA Liquid Mirror Telescope (‘LMT’) and Canadian Large Zenith Telescope (‘LZT’) are just examples of such spinning mercury large telescopes. These telescopes share a common shortcoming, however: they can only be pointed vertically (i.e. towards zenith) and cannot be aimed in other directions.

There are also proposals for paraboloid mirrors spin-cast from epoxy (US H2123 to Mollenhauer et al., U.S. Pat. No. 6,254,243 to Scrivens, U.S. Pat. No. 6,533,426 to Carreras et al.), made of magnetic rheological fluids, etc.

There have also been non-industrial attempts to cast paraboloid mirrors with epoxy materials utilizing horizontal rotational tables, with varying success.

There have also been several deployable paraboloid radio antenna reflectors based on shape-memory materials which resemble in their shape the final shape of the proposed paraboloid mirror.

For example, U.S. Pat. Nos. 11,322,851 and 11,398,681, both to present inventor, teach a shape-memory deployable rigid paraboloid antenna reflector and a paraboloid antenna based on shape-memory deployable rigid ribs supporting a flexible reflector, respectively.

Also, U.S. Pat. No. 7,710,348 to Taylor et al. teaches a deployable antenna reflector which utilizes a shape-memory element to open conventional rigid ribs supporting a flexible reflector.

U.S. Pat. Nos. 8,259,033 and 9,281,569, both to Taylor et al. teach a deployable antenna reflector with longitudinal and circumferential shape-memory stiffeners supporting a reflective elastic material.

None of the prior art above suggests or teaches a paraboloid mirror created in space.

None of the prior art above suggests or teaches a deployable shape-memory mirror support created from a pliable material.

None of the prior art above suggests or teaches an extendable boom structure actuated by- or constructed from, shape-memory materials.

None of the prior art above suggests or teaches a mirror support which is stiffened prior to deposition of the main mirror precursor material.

None of the prior art above suggests or teaches a mirror support impregnated with a photopolymer which is stiffened by exposure to UV light prior to deposition of the main mirror precursor material.

Also, none of the prior art above suggests or teaches a structure which would create a paraboloid mirror while in space, as per instant invention.

None of the prior art suggests or teaches a mirror repairable- or re-formed in space.

### Objects and Advantages

Large Optical Apertures Possible

In contrast to the prior art mentioned hereinabove, the present invention describes a structure which would be, while being compact at launch, when in space, create and deploy a paraboloid mirror of the size enabling imaging at significantly improved resolution. For example, a ‘3U’ (300×100×100 mm³) ‘small’ satellite can have a mirror of up to 1 meter in diameter.

Having a large aperture (diameter) of an optical component, such as a mirror, is critical for improved imaging, since optical resolution is directly related to the size of the aperture:

$${α}_{D} = 1.22 \frac{λ}{D} \qquad ( 1 )$$

Where
α_{D} is angular resolution (smaller value is desirable)
λ is wavelength of light
D is the aperture (optical element effective diameter)

In low-, micro-, or zero-gravity environments, the size of the mirror support and its boom are limited only by structural rigidity requirements during structure's maneuvers and their ultimate strength during mirror generation maneuvers.

Thus, very- to extremely-large mirrors are possible to construct in space.

High Volumetric Storage Efficiency

The pliable mirror support in its stowed configuration does not require extensive specialized supports for protection during launch due to its compact size and weight. The mirror support and deployment structures are also effectively ‘self-deploying’, in that they do not require auxiliary mechanisms for their deployment, other than electrical current for their heating.

The resulting mirror can also be much lighter than the present ones, because it does not carry with it the deploying or assembly structures, saving on launch cost and complexity, and saving the on-board propellant for on-orbit structure/satellite maneuvering. Both the material used (for example, a photopolymer) and the volume (a thin film) of the mirror material can be orders of magnitude lighter than even the lightest present solid paraboloid space mirrors.

Light Weight

The mirror support of instant invention comprises a thin lightweight pliable shell. In addition, due to the absence of the relatively heavy mechanical deployment mechanisms and their associated interfaces, the weight of instant mirror system is greatly reduced. The required actuating heat is generated by passing electric current directly through the support struts and support hoop. A completely passive heating and deployment of mirror support can be also achieved by exposing the mirror system elements to sunlight by appropriately maneuvering the structure. In the vacuum of space, solar heating can be considerable.

Simplified Construction: ‘Self-Deployable’ System

The mirror system of instant invention comprises a limited number of parts. There are no separate ‘actuators’ per se, other than shape memory struts and boom actuators in some embodiments. The system elements literally deploy themselves upon application of heat, by utilizing elastic mechanical energy stored at the time of their packaging.

Improved Reliability, Easier Redundancy Implementation

With thermal actuation of elements of instant invention replacing present electro- and mechanical actuators the instant imaging system is much more reliable, since the only moving parts are the system elements themselves. In addition, the shape-memory elements do not require special rotating or sliding joints.

Potentially, with timed heater activation very specific and precise deployment sequences are possible to minimize the risk of malfunction or mechanical interference.

Since it is much easier to provide redundancy to an electrically heated deployment system than to a mechanical actuator(s)-based one, the shape-memory based mirror support system possesses enhanced redundancy of its deployment apparatus.

High Stored Mechanical Energy

The shape-memory materials used for the mirror support and the boom store considerable mechanical elastic energy at the time of their packaging and can generate considerable forces during deployment, to overcome potential adhesions, friction and snags. This improves overall reliability of the mirror deployment and therefore, the reliability of the entire system.

Optional Deployment by Sunlight

As mentioned above, since heating of objects in space by solar radiation can be considerable, the instant mirror system elements can be exposed to sunlight instead of heaters for deployment. This also can be used as a backup procedure in case of heater malfunction.

Optional Precursor Material Curing by Sunlight

Solar radiation in space contains large amount of UV light which can be advantageously used to crosslink the mirror photopolymer material precursor, both for the support stiffening as well as for the mirror generation.

In-Space Mirror Testing and Repair/Regeneration

The completed mirror can be tested by pointing it towards a star (a virtually perfect light point source) and analyzing the resulting image. If required, the mirror can be repaired/re-cast in space by repeating its casting/solidification/curing procedures.

### BRIEF DESCRIPTION OF THE DRAWINGS

FIG. 1 is a perspective view of the imaging satellite 50 containing coiled support hoop 46 in storage/launch configuration.

FIG. 1A is a perspective view of the imaging satellite 50a containing folded support hoop 48 in storage/launch configuration.

FIG. 2 is a perspective exploded view of the mirror assembly 88, mirror support 40, coiled support hoop 46, support struts 160, precursor material container 30, and imaging/curing/coating sub-system 70 all in stowed configurations.

FIG. 2A is a perspective exploded view of the mirror assembly 89, mirror support 40, folded support hoop 48, support struts 160, precursor material container 30, and imaging/curing/coating sub-system 70 all in stowed configurations.

FIG. 3 is a perspective view of the mirror assembly 88, mirror support 40 and coiled support hoop 46.

FIG. 3A is a perspective view of the mirror assembly 89, mirror support 40 and folded support hoop 48.

FIG. 4 is a perspective view of the view of the mirror assembly 88a, including mirror support 40 in its deployed configuration 40a, supported by un-coiled deployed support hoop 46a.

FIG. 5 is a perspective view of the mirror assembly 89a, including the mirror support 40 in its deployed configuration 40a, supported by un-folded deployed support hoop 48a.

FIG. 6 is a perspective view of the coiled support hoop 46 connected to the heating electrical source 220.

FIG. 6A is a perspective view super-elastic variant 46d of the coiled support hoop constrained within meltable constraining sleeve 25.

FIG. 7 is a perspective view of the folded support hoop 48 connected to the heating electrical source 220.

FIG. 7A is a perspective view of the super-elastic variant 48d of folded support hoop constrained by meltable cord 25a.

FIG. 8 is perspective view of the strut 160.

FIG. 9 is a cross-sectional view of the alternate embodiment 161 of strut.

FIG. 10 is a perspective fragmentary view of woven mirror support 40b.

FIG. 10A is a cross section fragmentary view of woven mirror support 40b showing UV light injection and propagation within it.

FIG. 11 is cross-sectional views of a solid cylindrical strut 160 variants taken along the line 11-11 on FIG. 8, before and after actuation.

FIG. 12 is a cross-sectional view of a tubular strut variant 162 before and after actuation.

FIG. 13 is a cross-sectional view of a tubular strut variant 163 before and after actuation.

FIG. 14 is a perspective view of the satellite 50 or 50a with mirror supports 160 in their deployed configuration 160a prior to mirror generation.

FIG. 15 is a perspective view of satellite 50 or 50a with the mirror 88a or 89a created.

FIG. 16 is a cross-sectional view taken along line A-A on FIG. 15 of mirror support 40 in its deployed configuration 40a showing mirror precursor material flow.

FIG. 17 is a fragmentary cross-section view of FIG. 16 illustrating the formation of the paraboloid shape of the mirror, with optional stiffener 60a.

FIGS. 18-20 are perspective views of variants of mirror precursor material container assembly 30.

FIG. 21 is a perspective view of the imaging, photopolymer curing and coating sub-assembly 70.

FIG. 22 is a cross-section view taken along the line 22-22 on FIG. 21.

FIG. 23 is a fragmentary cross-section view 23 on FIG. 22.

FIG. 24 is a perspective view of the deployable boom 120 in stowed configuration.

FIG. 25 is a perspective view of the deployable boom 120 in its deployed configuration 120a.

FIG. 26 is a schematic of heating mechanism for struts 160.

FIG. 27 is alternative schematic of heating mechanism for struts 160.

FIG. 28 is a perspective view of the telescopic deployable boom 140 in its stowed configuration.

FIG. 29 is a perspective view of the telescopic boom variant 140 in its deployed configuration 140a.

FIG. 30 is a perspective view of the corrugated deployable boom 150 in its stowed configuration.

FIG. 31 is a cross section taken along line 31-31 of the FIG. 30.

FIG. 32 is a perspective view of the corrugated boom 150 with attached mirror assembly 88 in their stowed configurations.

FIG. 32A is a perspective view of the corrugated boom 150 with attached mirror assembly 89 in their stowed configurations.

FIG. 33 is a perspective exploded view of the mirror support 40, mirror precursor material container assembly 30, coiled support hoop 46, struts 160, imaging/curing/coating sub-assembly 70, pivoting assembly 75 and corrugated boom 150, all in stowed configurations.

FIG. 33A is a perspective exploded view of the mirror support 40, mirror precursor material container assembly 30, folded support hoop 48, struts 160, imaging/curing/coating sub-assembly 70, pivoting assembly 75 and corrugated boom 150, all in stowed configurations.

FIG. 34 is a perspective view of the corrugated boom 150 in its deployed configuration 150a.

FIG. 35 is a perspective view of the tubular coiled boom variant 190 in stowed configuration.

FIG. 36 is a perspective view of the tubular coiled boom 190 in its deployed configuration 190a.

FIG. 37 is a perspective view of satellite 50 or 50a with mirror support 40a and tubular boom 120a in their deployed configurations.

FIG. 38 is a perspective view of satellite 50 or 50a with mirror support 40a in the pivoted operational configuration.

FIG. 39 is a fragmentary view 39 on FIG. 38.

FIG. 40 is a flowchart 600 of mirror support 40 deployment sequence.

FIG. 40A is a flowchart 600a of mirror support hoop 46 or 48 deployment sequence.

FIG. 41 is a flowchart 700 of mirror generation Sequence 1.

FIG. 42 is a flowchart 800 of alternate mirror generation Sequence 2.

FIG. 43 is a flowchart 800a of alternate mirror generation Sequence 2a.

FIG. 44 is a flowchart 900 of alternate mirror generation Sequence 3.

### DESCRIPTION OF THE EMBODIMENTS

In the foregoing description like components are labeled by the like numerals.

It also should be noted that the collective designation ‘satellite’ refers not only to satellites in the conventional sense, but space-borne structures utilizing imaging systems, such as space telescopes and such.

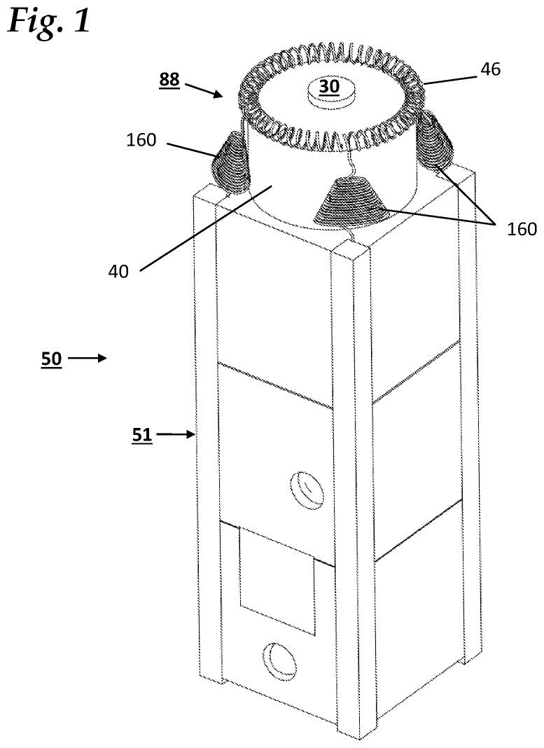

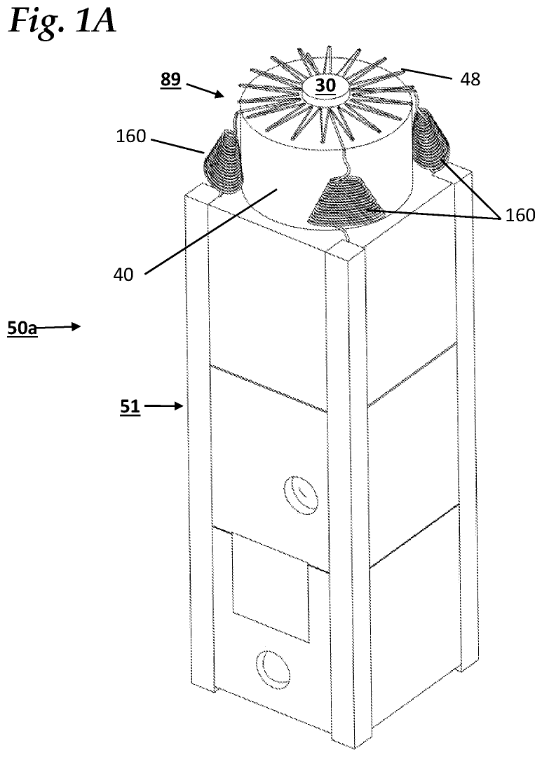

Referring to FIG. 1 satellite 50 in its pre-deployment configuration comprises satellite body 51 and attached to it mirror assembly 88, which in turn includes mirror support 40 in its stowed configuration, and mirror precursor material container 30. Mirror support 40 is further connected to coiled support hoop 46 which is held by deployable struts 160, all shown in their respective stowed configuration.

Referring to FIG. 1A an alternate satellite 50a embodiment in its pre-deployment configuration comprises satellite body 51 and attached to it mirror assembly 89, which in turn includes mirror support 40 in its stowed configuration, and mirror precursor material container 30. Mirror support 40 is further connected to folded support hoop 48 which is held by deployable struts 160, all shown in their respective stowed configuration.

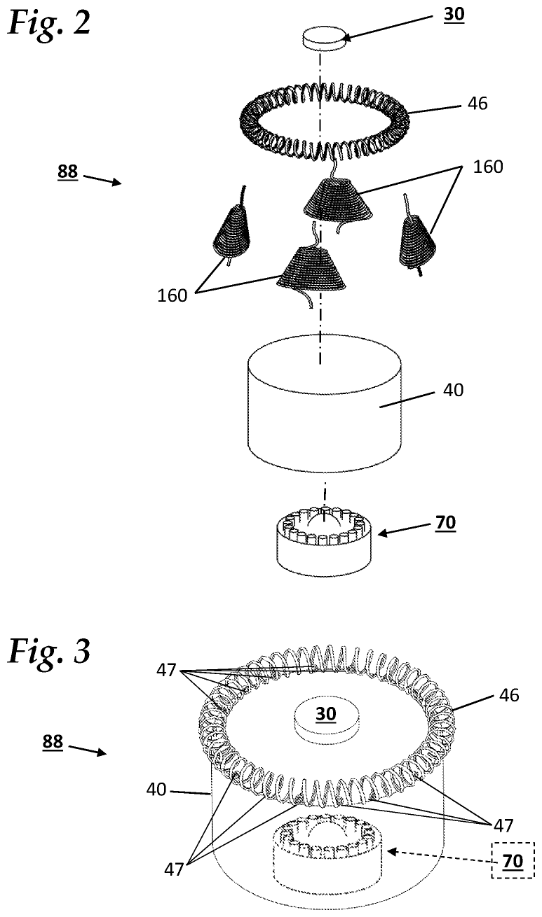

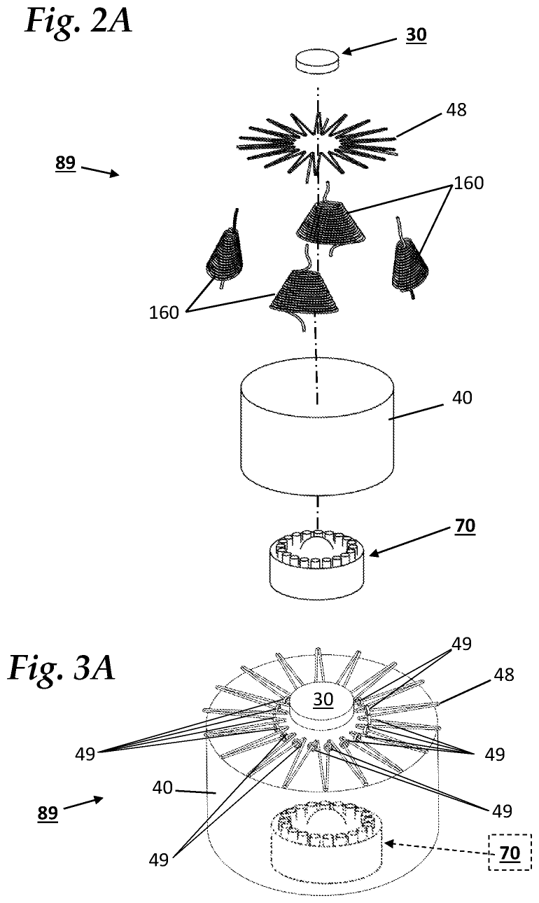

FIGS. 2 and 2A in addition to showing components of mirror assembly 88 and 89, respectively, also show imaging sub-system 70 which is located underneath mirror support 40 when it is in stowed configuration.

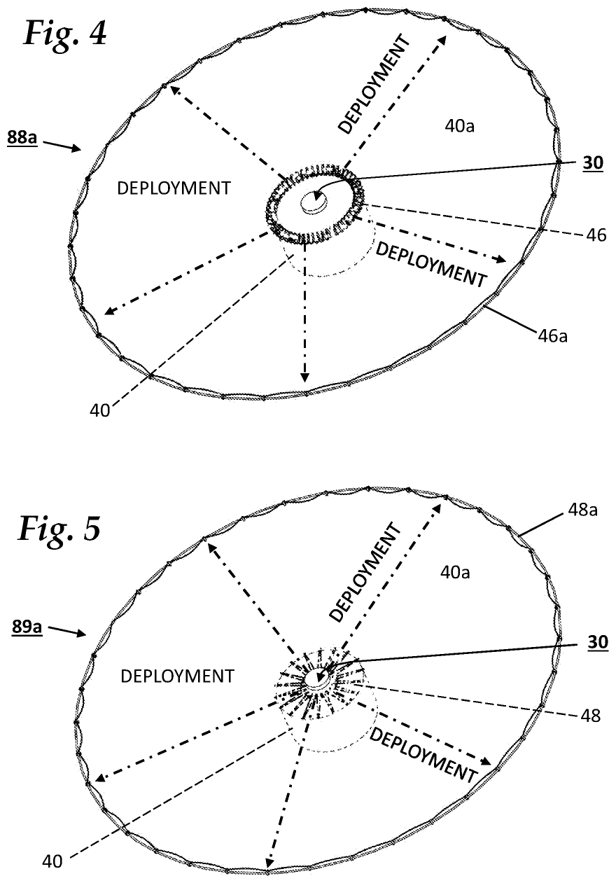

On FIG. 3 mirror support 40 of mirror assembly 88 is attached to support hoop 46 by a plurality of attachment rings 47. This enables hoop 46, when it deploys into its 46a configuration, to stretch support 40 to its deployed shape 40a, as shown on FIG. 4.

On FIG. 3A mirror support 40 of mirror assembly 89 is attached to support hoop 48 by a plurality of attachment rings 49. This enables hoop 48, when it deploys into its 48a configuration, to stretch support 40 to its deployed shape 40a, as shown on FIG. 5.

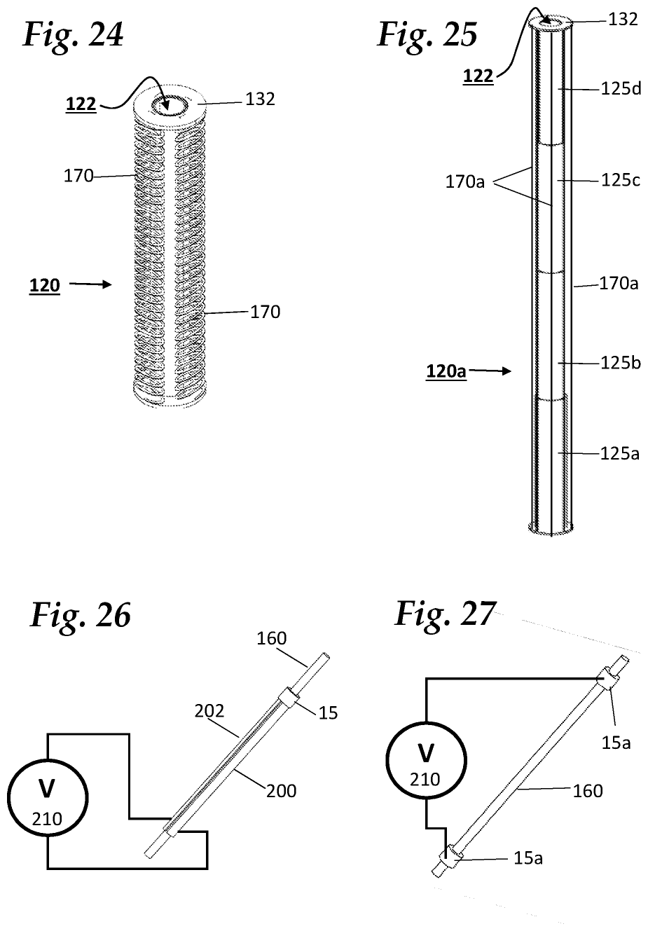

Mirror support 40, support hoops 46 or 48, struts 160 and their variations, precursor material container 30, are supported by deployable boom 120 and its variations 140, 150, 190, as shown on FIGS. 24, 25, 28, 29, 30-32A, 35, and 36.

Shape-memory materials used in the instant mirror support construction may include shape-memory alloys (‘SMAs’) or shape-memory polymers (‘SMPs’).

Shape-memory alloys comprise numerous alloys such as AgCd, AuCd, cobalt-, copper-, iron-, nickel- and titanium-based, with most well-known and used being Cu—Al—Ni and Ni—Ti alloys (the latter known as ‘nitinols’).

Shape-memory polymers comprise linear block polymers such as polyurethanes, polyurethanes with ionic or mesogenic components made by prepolymer method, block copolymer of polyethylene terephthalate (PET) and polyethyleneoxide (PEO), block copolymers containing polystyrene and poly(1,4-butadiene), and an ABA triblock copolymer made from poly(2-methyl-2-oxazoline) and polytetrahydrofuran.

Also, cross-linked PEO-PET block copolymers and PEEK can be used as shape-memory elements of instant invention.

Some of these SMPs can be made to contain carbon which makes them electrically conductive. This conductivity can be advantageous for their direct heating with electrical current of the mirror support and boom made from them.

### Operation

Mirror Support Deployment

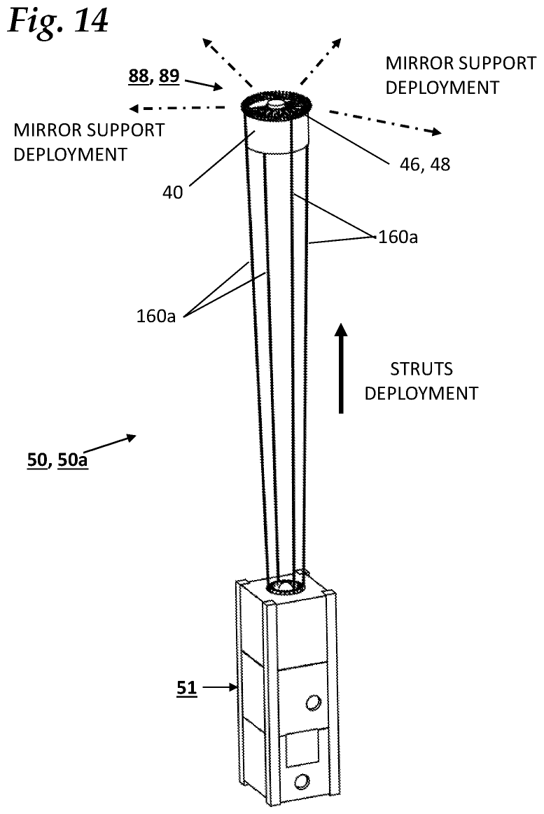

Referring to FIG. 14, prior to mirror generation mirror assembly 88 or 89 is displaced away from satellite body 51 of satellite 50 or 50a by struts 160 extending to their deployed configuration 160a by application of heat externally or direct heating by electrical current.

On FIG. 26 heat is applied to struts 160 by heaters 200 and 202 by electric current from source 210 which proceeds through heater 200, through connector 15 and returns to source 210 via heater 202. Electric current flowing through heaters 200 and 202 heats them, and they in turn heat strut 160.

An alternate heating mechanism of struts 160 is shown on FIG. 27. Electric current from source 210 proceeds through contact 15a, through strut 160 itself and through second contact 15a back to source 210, in the process heating strut 160.

Mirror support 40 is then stretched into its deployed configuration 40a via expanding coiled support hoop 46 or folded support hoop 48, as shown on FIGS. 4 and 5 respectively, which assume their respective deployed circular configurations 46a or 48a.

At its fabrication, support hoop 46 or 48 is ‘trained’ into a circular form 46a or 48a, respectively, to ‘set’ its ‘memorized’ shape. Afterwards, it is either coiled or folded into a compact pre-deployment shape 46 or 48, respectively.

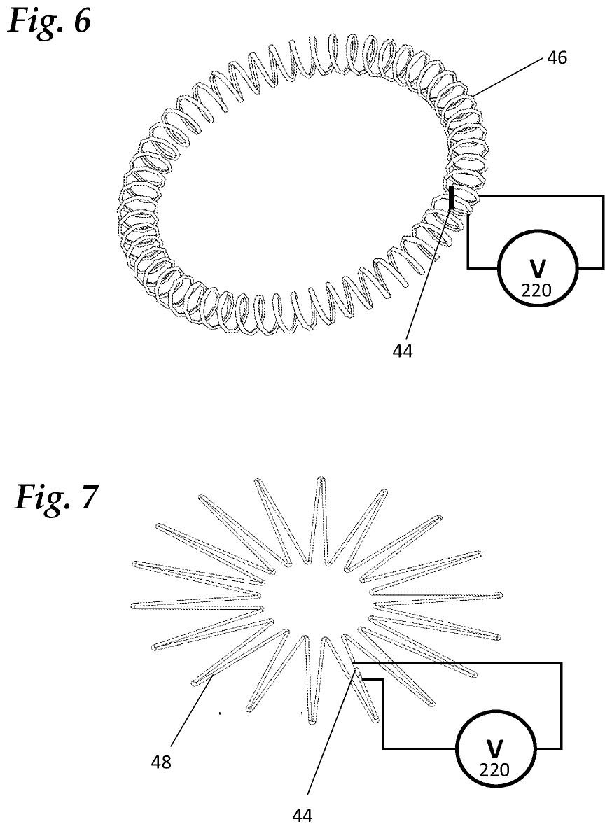

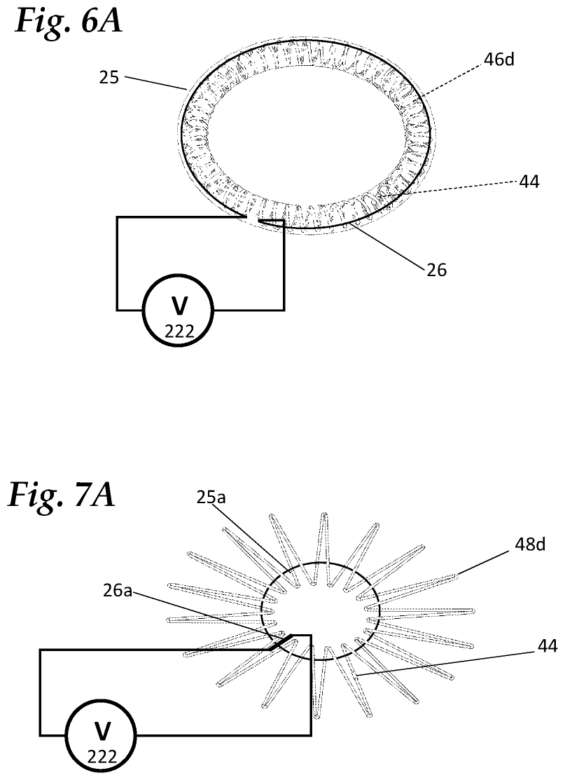

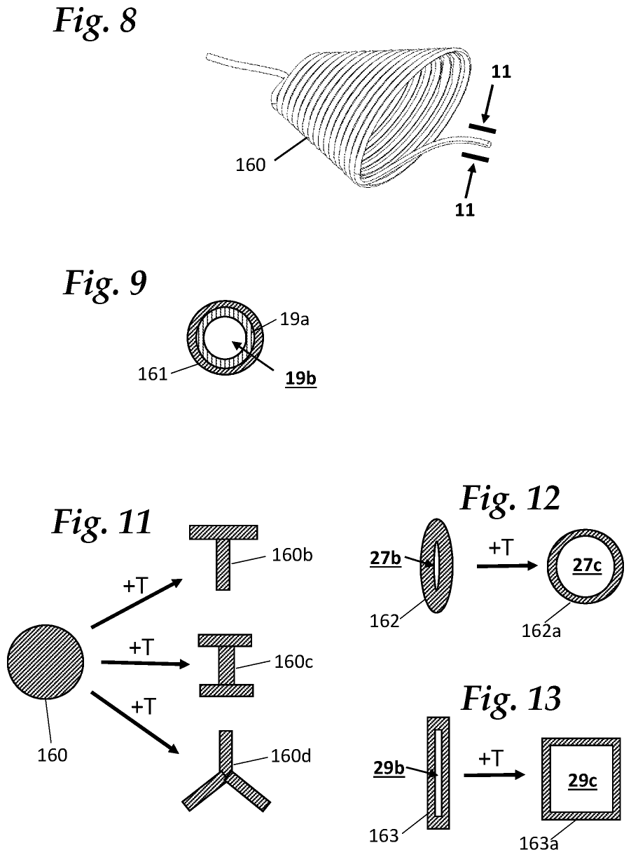

Deployment of support hoop 46 or 48 is effected by heating by passing electric current supplied by source 220 through it, as shown on FIGS. 6 and 7, respectively. To eliminate competing parallel electrical paths through support hoop 46 or 48 each of them contains insulating insert 44. This ensures a single electrical path from source 220 through the entire length of support hoop 46 or 48.

Shape memory materials preferably utilized for support hoops' 46 or 48, and struts' 160 construction, such as metallic Ni-based alloys are advantageously suited for direct heating by electric current, as they possess high electrical resistivity.

Mirror Support Stiffening Process A

Since mirror support 40 material is pliable, depending on its particular properties, such as a possible tendency to stretch, it may have to be stiffened and stabilized prior to mirror generation.

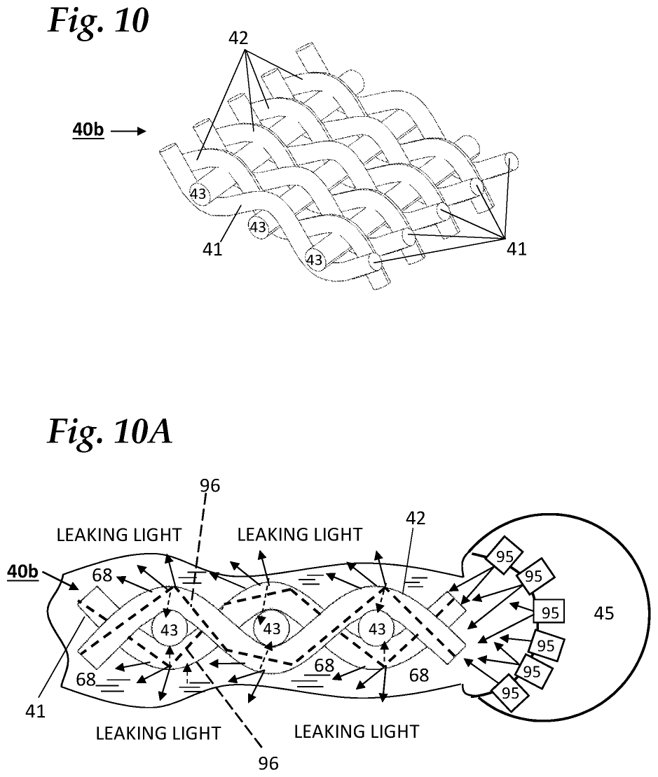

For one stiffening operation, shown on FIGS. 10 and 10A mirror support 40b is made of a woven fabric which uses UV light-guiding fibers, namely, first warp 41, second warp 42 and weft 43. Other fabric weaves can be used as well.

Mirror support 40b fabric is impregnated with a UV photopolymer 68 which as a result is located between- and around fibers 41, 42, and 43 of the support's 40b fabric and which remains in liquid or semi-liquid state until it is crosslinked and solidified. While remaining in liquid or semi-liquid state photopolymer 68 allows support 40b to remain pliable and foldable for compact stowage prior to launch.

Upon deployment of support hoop 46a or 48a and the resulting stretching of support's 40b fabric, photopolymer 68 is crosslinked by exposing it to UV light, thus stiffening support 40b.

UV light can be supplied from UV sources 90 which are also used for the mirror generation.

Alternatively, UV light can be supplied by sunlight in space.

Alternatively still, UV light can be supplied by a plurality of UV light-emitting diodes (‘LEDs’) 95 contained in the periphery of an alternative embodiment of support hoop 45 as shown on FIG. 10A.

On FIG. 10A UV LEDs 95 inject light into light-guiding fibers 41 and 42 which guide it from the periphery of now-deployed circular support hoop 45 towards its center as partially internally reflecting light rays 96.

As rays 96 travel inside fibers 41 and 42, they partially escape out of them at these fibers' intersections with fiber 43 due to these intersections containing bends which induce light scattering and escaping. Some of this escaping light couples into fibers 43 and propagates further, and some of it escapes fibers altogether and crosslinks surrounding them photopolymer 68 thus stiffening support 40b as a result.

Some of the light captured by fibers 43 re-enters fibers 41 and 43 at their respective intersections and re-emerges from them throughout support's 40b fabric, to crosslink more photopolymer 68 and stiffen more area of support 40b.

Eventually, the entire support 40b becomes stiffened in this fashion.

Because of this, it is advantageous to have a woven, rather than a non-woven fabric for 40b support, as a non-woven fabric will not be able to distribute crosslinking UV light as efficiently and uniformly.

Photopolymer 68 can be distinct from-, be similar-, or identical to photopolymer 60 used for mirror generation, depending on the particular properties of support's 40b fabric and demands of the subsequent mirror generation process.

Light-guiding fabrics of the type required by support 40b are well-known in the art and are commercially available. For example, one such material, called ‘The Fiber Optics Fabric’ is available from LumiGram Company of Lodi, Italy.

Mirror Generation Process

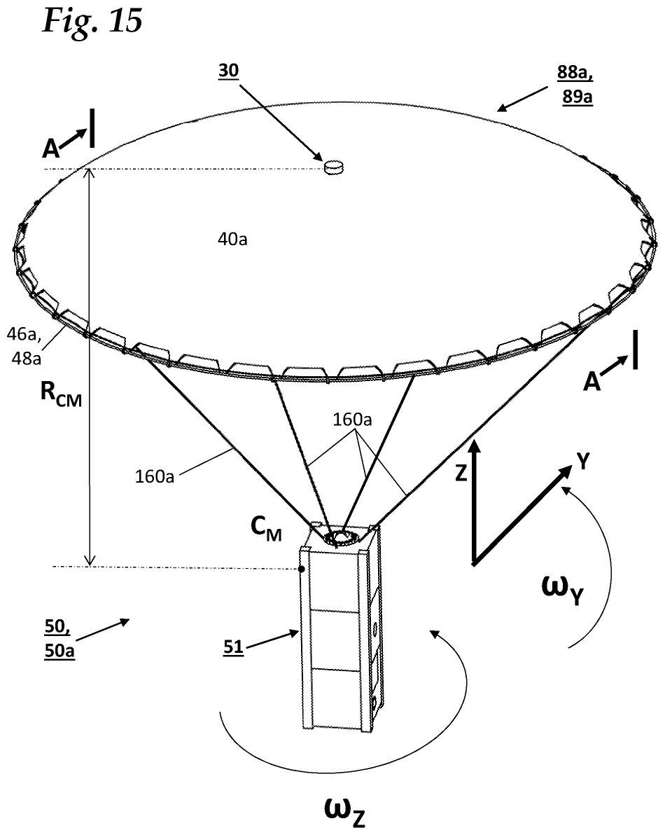

The mirror surface generation then proceeds with satellite 50 or 50a spinning in two orthogonal axes as shown on FIG. 15 to create the paraboloid mirror surface.

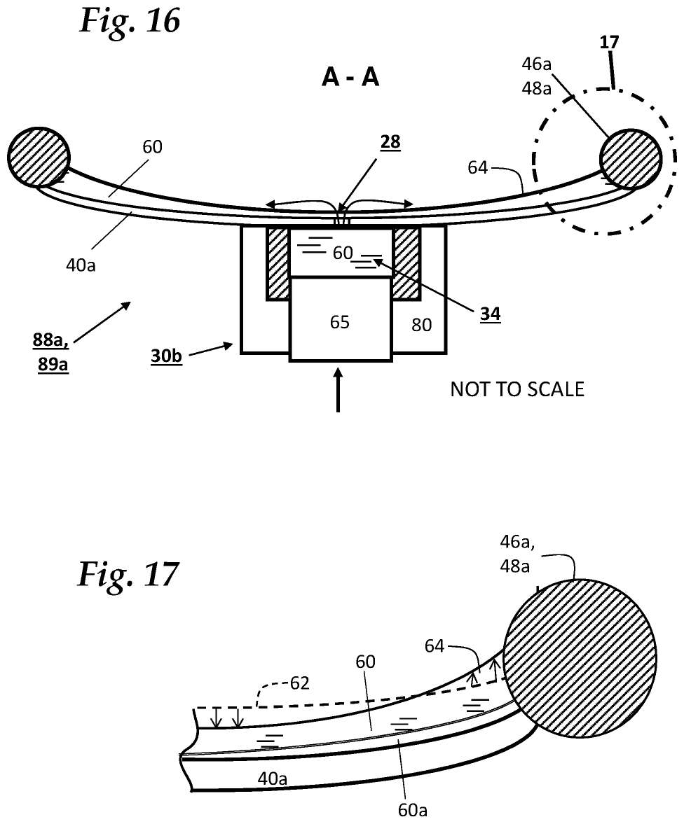

At first, satellite 50 or 50a spins around its center of mass C_{M} in Y-axis with angular velocity ω_{Y} while liquid mirror precursor material 60 held in container assembly 30 is ejected onto deployed support 40a by the action of piston 65 via aperture 28 per FIG. 16.

Subsequently, satellite 50 or 50a, while spinning around the Y-axis, start spinning around its longitudinal Z-axis with angular velocity ω_{Z}. This compound spinning around the X- and Y-axes generates required forces on the liquid precursor material 60 for it to assume the desired paraboloid shape.

Rotation around the satellite's Y-axis creates a centripetal force analogous to the gravitational force on the Earth's surface. Rotation around the satellite's Z-axis creates its own centripetal force which distributes liquid mirror precursor material 60 inside deployed mirror support 40a. The cooperative action of these two forces creates a paraboloid mirror surface.

This spinning of satellite 50 or 50a can be effected via compressed gas jets, pyrotechnical charges, internal rotating inertial masses or external mechanism(s).

The focal length of the resulting mirror can be calculated from the following equation (2).

$$f = \frac{{R}_{C M}}{2} {( \frac{{ω}_{Y}}{{ω}_{Z}} )}^{2} \qquad ( 2 )$$

Where
f is the focus length of the resulting paraboloid mirror
R_{CM} is the radius of rotation around satellite center of mass
ω_{Y} is angular velocity around satellite's Y-axis
ω_{Z} is angular velocity around satellite's Z-axis

The Coriolis force contribution and liquid surface tension of mirror material 60, while present, to a first approximation are not included in this analysis. It is generally accepted that the Coriolis force will effectively tilt the center line of the created paraboloid. This tilt is predictable and ascertainable from the system operation parameters and will be readily compensated for by the mechanical design of the mirror support and optical system design. Proper selection of the mirror material 60 and intrinsic material or coating of support 40 would ensure its proper wetting by material 60.

When liquid mirror precursor material 60 covers the surface of support 40a, upon rotation its outer surface transforms from initially flat layer 62 into a smooth paraboloid surface 64 as shown on FIG. 17.

In case of molten metals or polymers or two part epoxy or thermosetting polymers used as precursor, liquid mirror precursor material 60 is then permitted to cool and solidify, at which point the rotation of the satellite is stopped. The cooling rate of material 60 may have to be controlled for a particular mirror material, for example a flash cooling to create an amorphous metal ‘glass’ with superior surface quality.

Metals and alloys with low melting temperature include sodium (Na), potassium (K), indium (In), gadolinium (Ga), tin (Sn), lead (Pb) and mercury (Hg) as well as alloys of these metals.

Thermo-setting polymers are also suitable, such as polyesters, phenolic resins, vinyl esters, polyurethane; silicones, polyamides, polyamide-imides, and others.

Thermoplastic polymers such as polypropylene, polyethylene, polyvinylchloride, polystyrene, polyethylenetheraphthalate and polycarbonate and others can be also be used.

Curing/Solidification of Photopolymer Precursor Material

In case of a photopolymer precursor being used, liquid mirror precursor material 60 is cured by exposure to ultraviolet (′UV) light supplied by UV light source or sources 90. Most of UV-curable materials require UV irradiation in the 240-405 nm wavelength range. Such illumination is achievable with UV light-emitting diodes (LEDs), vapor-discharge lamps, or lasers. Such LEDs are commercially available. For example, UV LED Model 6868 by Inolux Company (San Jose, California, USA) produces 10 Watts of optical output at 365 nm wavelength while occupying a relatively small 6.8×6.8×3.7 mm³ envelope suitable for compact co-location of many such LEDs for a powerful precursor curing solution which would be capable of reliable and fast curing of photopolymer precursor.

Photopolymers are widely used in industry as potting and adhesive compounds. Commonly used photopolymer materials comprise cycloaliphatic epoxies, cyanoacrylates and such. For example, UV-curable polymer Model UV18Med by Master Bond Corporation (Hackensack, New Jersey, USA) is cured by exposure to 320-365 nm UV light source, does not contain or create volatile compounds and has an exceptionally low shrinkage upon curing. Another example is a UV22 nanosilica-filled UV-curable photopolymer system by Master Bond, Inc. which has high dimensional stability, very low thermal expansion coefficient and meets NASA low outgassing requirements, thus making it suitable for the instant application.

Reflective Coating(s) Deposition

Metallic precursor materials intrinsically possess high reflectivity and they do not generally require reflective coatings.

In contrast, since cured photopolymers, two-part epoxies or thermoset or thermoplastic polymers do not generally possess high intrinsic reflectivity, they have to be coated with metallic or dielectric reflective films, after the mirror is solidified. To accomplish this an evaporative source(s) 98 is used to deposit a reflective coating or a set of coatings onto the completed mirror. Source 98 can have multiple chambers each containing a separate coating material and an output opening(s) 99 facing mirror 40 surface. To enable deposition, coating material is heated or vaporized by heater 260 and then its vapor accelerated towards the mirror surface by a high voltage source 250 connected between coating material 300 and accelerating grid 280. To concentrate the electric field and enable more efficient emission of the coating atoms, the shape of coating material source 300 can be made into a sharp-tipped cone, as shown on FIG. 23. The coating operation is conducted in the deep vacuum of space which is uniquely suitable for in-situ coating deposition.

While providing momentum to the coating particles via accelerating voltage also helps to keep their stream pointed onto the mirror surface and minimize or eliminate its spillover and possible contamination of the adjacent satellite structures. Any coating particles not intercepted by mirror support 40a will be launched into space and away from satellite 50 thanks to their momentum.

To further prevent coating materials from settling onto- and potentially contaminating the nearby imaging system 24, source 98 can be recessed with respect to the coater output openings 99 as shown on FIGS. 22 and 23.

Several coating sources 98 utilizing various materials can be used to deposit multi-layer reflective coatings, simultaneously or sequentially. Coaters 98 are designed to expressly have such a capability. The coating materials can comprise metals, for example gold (Au), silver (Ag) or aluminum (Al), or dielectric materials such as SiO₂, Si₃N₄, CaF₂, GeO₂, MgF₂, Al₂O₃. High reflectivity multilayer coatings utilizing these and similar materials are well known in the art. For example, high reflectivity multilayer coatings are customarily made with alternating layers of materials with low refractive indices such as magnesium fluoride (MgF₂) and silicon dioxide (SiO₂) and materials with large refractive indices, such as zinc sulfide (ZnS) and titanium dioxide (TiO₂). For high reflectivity in extreme ultra-violet (EUV) alternating layers of molybdenum (Mo) or tungsten (N) can be interspersed with lightweight materials such as silicon (Si).

Since the mirror operates exclusively in the deep vacuum of space, chemically reactive materials otherwise unsuitable for terrestrial applications, such as alkali metals, may also be readily used for coatings. Advantageously, some alkali metals such as potassium (K) mentioned hereinabove have unique reflectance properties which can be advantageously exploited in space environment.

Boom Deployment

An extendable boom is used to relocate/reorient the created mirror with respect to the rest of satellite 50 or 50a to enable relatively un-obstructed field-of-view of the mirror.

For example a telescopic embodiment of boom 120 is stored inside satellite's 50 or 50a body 51.

As shown on FIGS. 24 and 25 boom 120 comprises several nested telescoping tubular sections 125a, 125b, 125c and 125d which are extended by the action of shape-memory actuators 170 which are coiled for stowage. Actuators 170 extend to their deployed shape 170a by action of heat, in turn extending boom 120 into its deployed configuration 120a.

Tilting the Completed Mirror

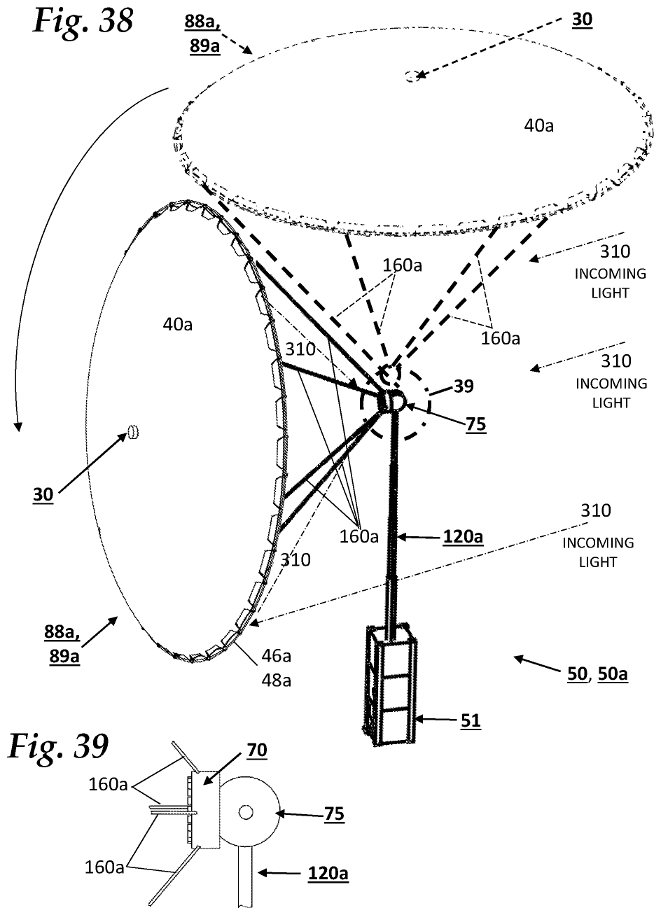

It is important to prevent satellite body 51 from obscuring field of view of the mirror and through it, imager 24 and permit light 310 from the observed object to reach imager 24 as shown on FIG. 38. This is achieved by tilting mirror support 40a and re-pointing it away from satellite body 51.

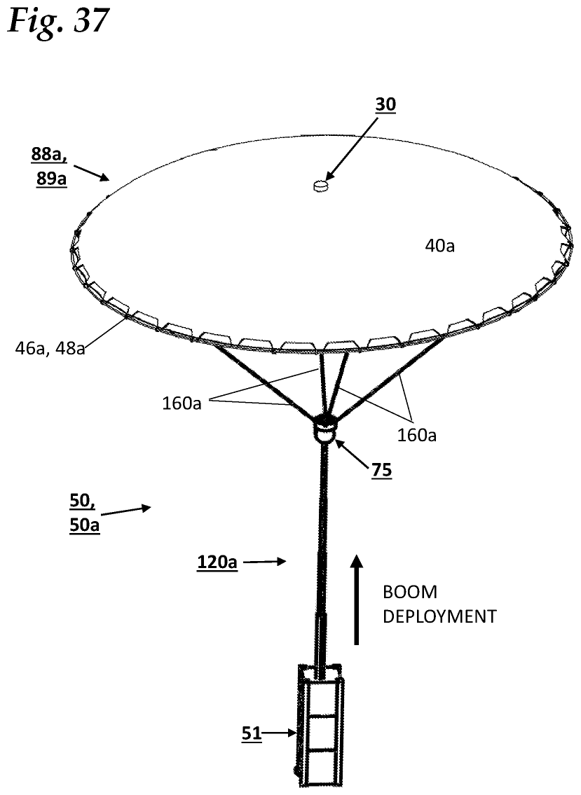

As shown on FIGS. 37 and 38 to position the completed mirror after boom 120a is extended, pivot drive 75 is activated and tilts mirror support 40a into its operational position.

Power and signal cables to imaging assembly 24, curing source(s) 90 and coater(s) 98 are routed inside lumen 122 of boom 120a. They may be pre-coiled or folded to facilitate their stretching as the boom is deployed. Such cable configurations are well known in the art.

Summary of Mirror Support Deployment and Surface Creation Operations

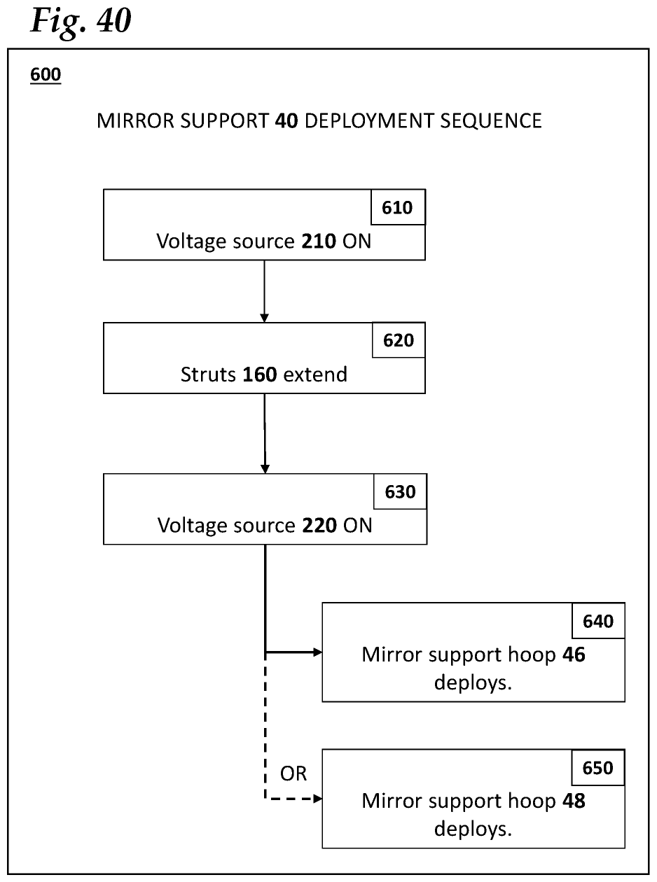

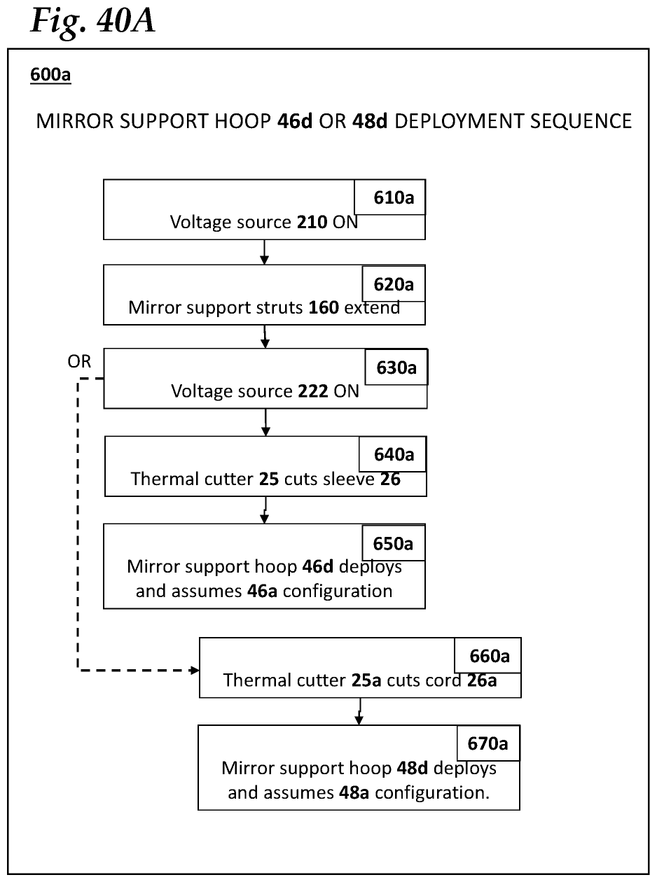

Referring to FIG. 40, sequence 600 pertains to deployment of mirror support 40. Struts 160 are extended by activating voltage source 210 (step 610), passing electric current directly through struts 160, heating them above their material's transition temperature and extending them into their deployed configuration 160a (step 620).

Mirror support hoop 46 or 48 is activated by passing electric current from voltage source 220 through it, to heat it above its material's transition temperature (step 630). In its deployed state support hoop 46 or 48 assumes a circular shape 46a or 48a, in steps 640 or 650 respectively.

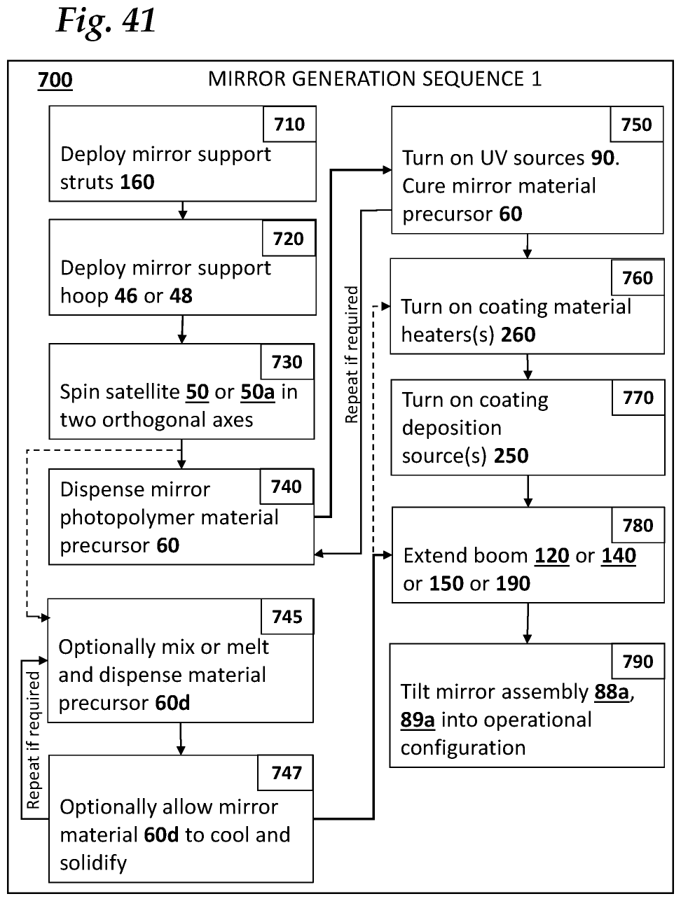

Referring to FIG. 41, in sequence 700 which pertains to mirror surface generation Sequence 1, supports 160 are extended by passing through them electric current supplied by heating voltage source 210 (step 710). Subsequently, mirror support 40 is deployed and assumes a paraboloid shape 40a (step 720). Satellite 50 or 50a is then spun around two orthogonal axes (step 730). Photopolymer precursor material 60 is then dispensed into support 40a (step 740) and, still in liquid state, creates a paraboloid surface due to satellite spinning action. Precursor 60 is then cured into solid paraboloid form by its exposure to UV light(s) 90 (step 750). Steps 740 and 750 may be repeated to build up the mirror thickness.

If a non-photopolymer precursor material 60d is used, it may have to be softened, melted or mixed (such as a two-part epoxy) prior to dispensing (step 745). For example, it can be heated by heater 63 of precursor container 30b. It is then allowed to solidify through cooling or polymerization (step 747). Steps 745 and 747 may be repeated to build up the mirror thickness.

For photopolymer precursor (also, optionally for non-photopolymer precursors), coating operation commences by turning on coating heater(s) 260 (step 760) and deposition high-voltage source(s) 250 (step 770).

After paraboloid mirror surface 64 (FIGS. 16 and 17) is created and optionally coated, boom 120 (or its variants 140, 150 and 190) is extended (step 780).

Finally, completed mirror assembly 88a or 89a is tilted by pivot drive 75 into operational position (step 790).

Mirror Generation with Support Stiffening Process A

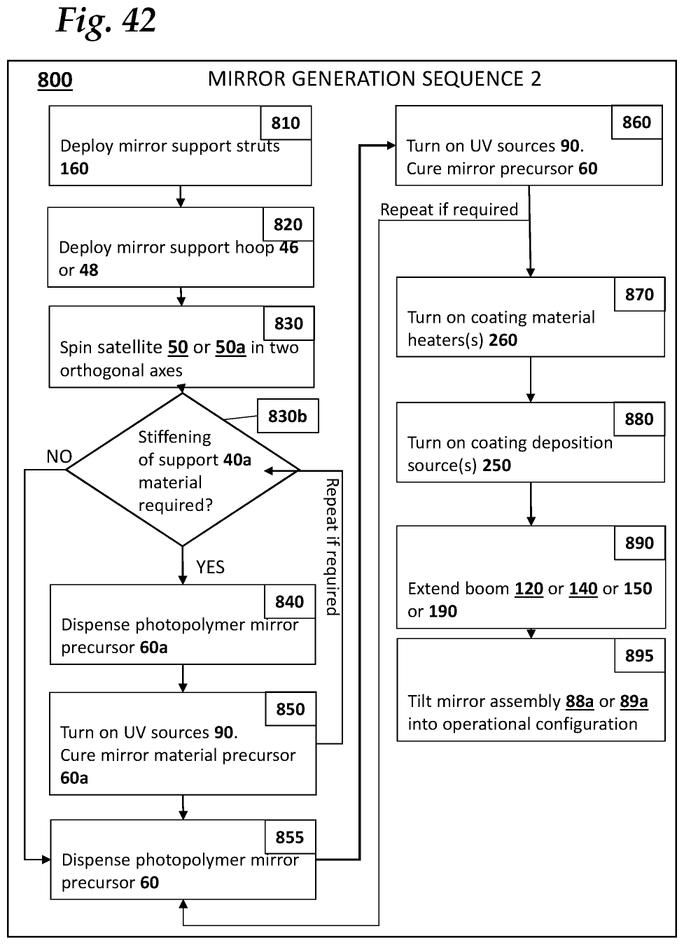

FIG. 42 is a flowchart 800 of mirror generation Sequence 2. Steps 810 through 830 are identical to steps 710 through 730 of flowchart 700. In step 830b, however, a decision is made whether to stiffen support material 40a prior to mirror photopolymer 60 dispensing. If affirmative, in step 840 a layer of the stiffening photopolymer 60a is deposited onto deployed mirror support 40a and is crosslinked by exposure to UV light from source 90 in step 850.

Thusly stiffened support 40a is then used for the generation of the rest of the mirror. Photopolymer 60a can be distinct from- or be the same photopolymer 60 used for mirror generation.

Mirror generation then proceeds with the deposition (while satellite 50 or 50a is spinning) of photopolymer 60 onto support 40a (step 855) and curing it by UV sources 90 (step 860). Steps 855 and 860 may be repeated to build up the mirror thickness.

The mirror coating steps 870 and 880 are equivalent to steps 760 and 770 of flowchart 700.

The mirror assembly deployment steps 890 and 895 are equivalent to steps 780 and 790 of flowchart 700.

### ADDITIONAL EMBODIMENTS AND PROCESS SEQUENCES

Mirror Generation with Support Stiffening Process B

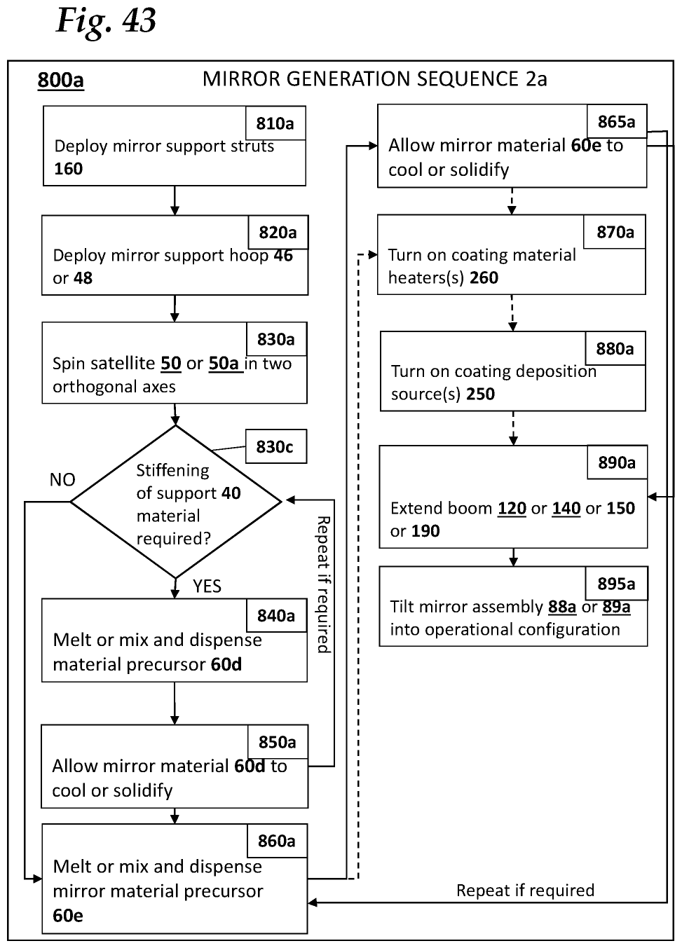

FIG. 43 is a flowchart 800a of mirror generation Sequence 2a which utilizes non-photopolymer stiffening and mirror precursors 60d and 60e, respectively. Steps 810a through 830a are identical to steps 810 through 830 of flowchart 800. In step 830c a decision is made whether to stiffen support material 40a prior to dispensing of mirror precursor 60d. If affirmative, in step 840a a layer of the stiffening meltable or mixed (such as two-part epoxy) precursor 60d is deposited onto deployed mirror support 40a and is allowed to cool and/or solidify in step 850a.

Thusly stiffened support 40a is then used for the generation of the rest of the mirror. Precursor 60d can be distinct from- or be the same 60e used for mirror generation.

Mirror generation then proceeds with the deposition (while satellite 50 or 50a is spinning) of precursor 60e onto support 40a (step 860a) where it subsequently is allowed to cool and/or solidify in step 865a. Steps 855 and 860 may be repeated to build up the mirror thickness.

The mirror coating steps 870a and 880a are equivalent to steps 870 and 880 of flowchart 800.

The mirror assembly deployment steps 890a and 895a are equivalent to steps 890 and 895 of flowchart 800.

Mirror Generation with Support Stiffening Process C

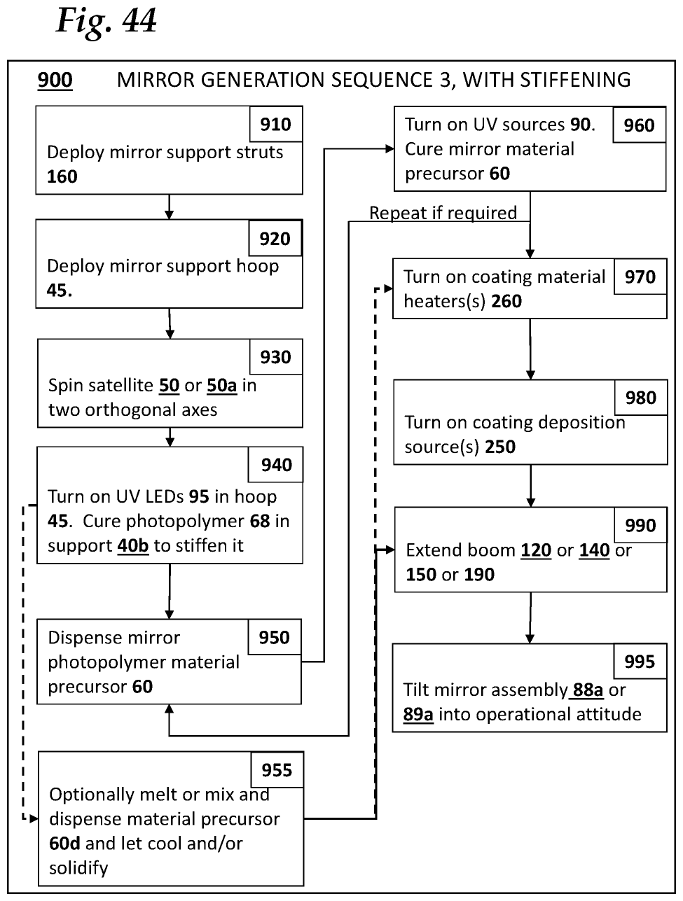

Mirror generation sequence 900 containing an alternate stiffening process is shown on FIG. 44. In step 910 struts 160 are deployed by being heated by current supplied by source 210.

Shape memory mirror support hoop 45 is deployed by being heated by source 220 (step 920). In step 930 satellite 50 or 50a is then spun in two orthogonal axes to stretch mirror support material 40b. UV sources 95 in hoop 45 are then turned on and crosslink photopolymer 68 impregnated in material 40b, stiffening it (step 940).

Liquid photopolymer 60 is then dispensed onto the newly stiffened material 40b (step 950) and is cured by UV sources 90 (step 950). This deposition-curing operation can be repeated to build up the thickness of the mirror.

Alternatively, although not shown, photopolymer 60 used for mirror generation can be cured by LEDs 95 in hoop 45, but this process is expected to be slow and inefficient, as the light escaping from fabric 40b, in order to crosslink photopolymer 60 would have to travel through the thickness of already-crosslinked stiffener photopolymer 68.

Alternatively, in step 955, after stiffening of material 40b instead of photopolymer 60, a molten or mixed (such as a two-part epoxy) material 60d can be dispensed onto material 40b and allowed to cool and/or solidify. This deposition-cooling/solidification operation can be repeated to build up the thickness of the mirror.

Mirror surface can then be coated in steps 970 and 980, and mirror assembly 88a or 89a subsequently displaced with respect to satellite's body 51 by extension of boom 120 or 140 or 150 or 190 (step 990) and tilted into operational attitude in step 995.

Mirror Support Hoop Super-Elastic Variants

Mirror support hoop 46 or 48 can be made self-opening by exploiting the super-elastic properties of shape-memory materials, such as, for example NiTi (‘nitinol’) alloys. At above their phase-transition temperatures such alloys exhibit super-elastic properties which are characterized by very large elastic coefficients: the items made from them after removal of constraint return to their original shape even after being greatly deformed. Mirror support hoop 46d or 48d made from these materials and operated in their super-elastic mode (vs. temperature-sensitive shape-memory mode), unfold on their own in space into a deployed shape 46a or 48a, respectively after being initially compressed into a stowed configuration.

Referring to FIG. 6A super-elastic variant 46d of coiled hoop 46 is prevented from premature deployment by fitted over it a toroidal restraining sleeve 25 made of heat-meltable polymer mesh. A circular thermal cutter 26 is positioned inside sleeve 25 along its circumference. Upon being heated by electrical current supplied by source 222, cutter 26 thermally cuts through sleeve 25 releasing hoop 46d which subsequently assumes its deployed configuration 46a. This deployment mechanism is well known in the art.

Referring to FIG. 7A a heat-meltable polymer cord 25a constrains super-elastic variant 48d of folded support hoop 48 to prevent its premature deployment. A thermal cutter 26a is located across cord 25a. Upon being heated by electrical current supplied by source 222, cutter 26a thermally cuts through cord 25a releasing hoop 48d which subsequently assumes its deployed configuration 48a. This type of deployment mechanism is well known in the art.

On FIG. 40A sequence 600a pertains specifically to deployment of super-elastic variants 46d or 48d of support hoop 46 or 48, respectively. Struts 160 are extended by activating voltage source 210 (step 610a), passing electric current directly through struts 160, heating them above their material's transition temperature, and extending them into their deployed configuration 160a (step. 620a).

Mirror support hoop 46d or 48d is deployed by thermal cutter 26 or 26a heated by voltage source 222 (step 630a) cutting through its restraining sleeve 25 (step 640a) or restraining cord 25a (step 660a), respectively. As a result, hoop 46d or 48d is then elastically unfolds into its deployed shape 46a (step 650a) or 48a (step 670a), respectively.

Mirror Testing, Calibration and Repair

To verify mirror shape and to test its alignment and surface quality satellite 50 or 50a is oriented to point the mirror towards a bright star, which can serve as a virtually ideal point light source.

By analyzing the shape and size of the image of the star the surface quality of the mirror, its shape and alignment can be ascertained. By utilizing the results of these measurements the subsequent images produced by the imaging system 24 can be optically or digitally corrected if required. The calibration and verification can be repeated if there is a suspicion that the mirror shape and alignment have somehow changed.

If the mirror has been damaged, deformed or its surface aged, or if there was a defect produced during its generation, it can potentially be over-cast with a UV-curable photopolymer. To achieve this, mirror support 40a is returned to its original attitude, an additional batch of liquid photopolymer 60 is dispensed onto the previously solidified mirror surface 64. Satellite 50 or 50a is then re-spun at rates compensating for the extended boom 120a, to spread photopolymer 60 and to form new paraboloid surface 64, and then photopolymer 60 is again cured with UV light source(s) 90 and coated as previously. This operation will necessitate an additional capacity of the precursor material holding tank 30, or additional precursor holding tanks, or a controlled dispensing action of material expelling piston 65 which will not dispense the entire volume of precursor 60 in the first mirror forming operation, but will preserve some for potential re-casting operations. A dedicated heater in addition to heater 63 may be required to maintain precursor 60 in liquid form, or to heat/thaw it prior to dispensing.

Curing light source(s) 90 do not have to produce just an ultraviolet light in order to cure precursor 60, but visible or even infrared light can be used instead. Some photopolymers can be cured by visible light, as described in U.S. Pat. No. 9,902,860 to Li et al., or even by either UV or IR radiation per U.S. Pat. No. 5,466,557 to Haley et al.

Additionally, cross-linking of precursor polymeric material(s) can be accomplished by exposing them to other types of radiation, such as for example, ionizing. This technique is commonly used in manufacturing of the heat-shrink tubing.

If a meltable precursor material was used initially to generate the mirror, for example, a metal alloy with low-melting temperature, for repairs the mirror can also be potentially re-cast or re-melted

To re-cast the mirror surface with a molten or mixed precursor, the precursor material melting or mixing, casting and coating (if required) operations will be repeated. The entire mirror can be heated for the material to melt, or a new batch of the mixed or molten precursor material deposited onto the existing material layer. In the former case, mirror support 40a will have to have a heater or heaters pre-installed. Mirror support 40a will be tilted back into the starting position, and satellite 50 or 50a will again be spun along two orthogonal axes to re-generate parabolic mirror surface. The relative rates of rotation ω_{Y} and ω_{Z} will be changed in order to compensate for the length of the extended boom 120a.

Boom Variants

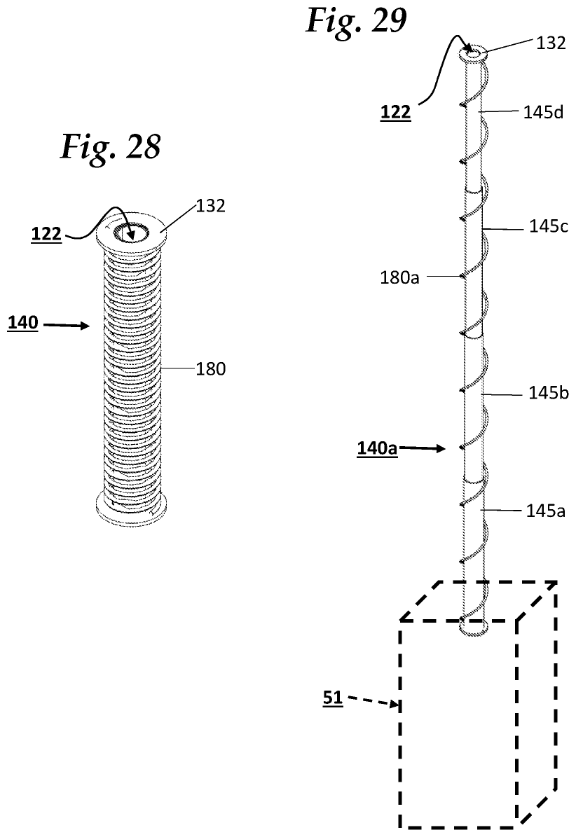

The system's boom can be realized in several configurations in addition to boom 120. Telescopic boom assembly 140 shown on FIGS. 28 and 29 comprises nesting telescopic sections 145a, 145b, 145c and 145d which are deployed by the action of extending shape-memory coil actuator 180 acting on flange 132 attached to section 145d. Coil 180 is stowed in its compact configuration prior to boom deployment and straightens to its extended form 180a upon application of heat, either indirectly from an external heat source (not shown) or by passing electrical current directly through it.

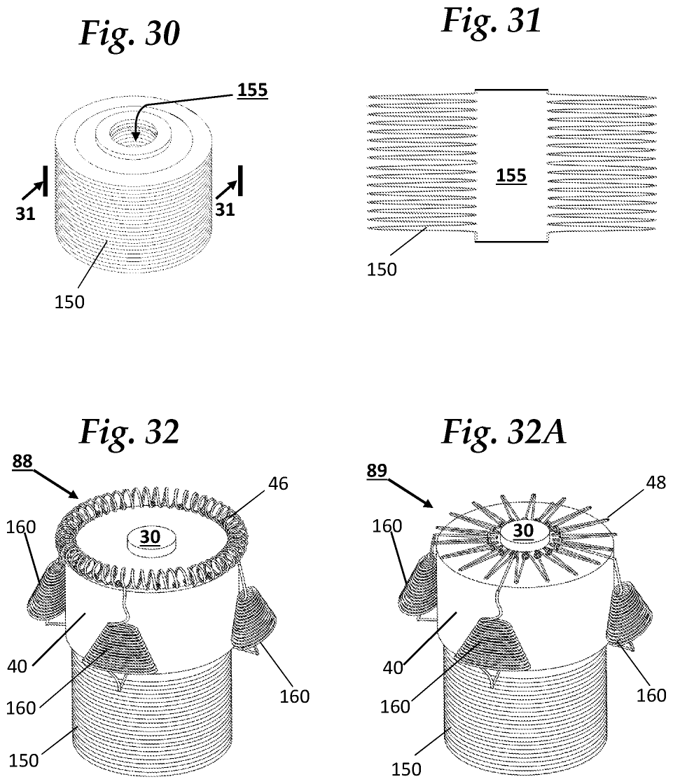

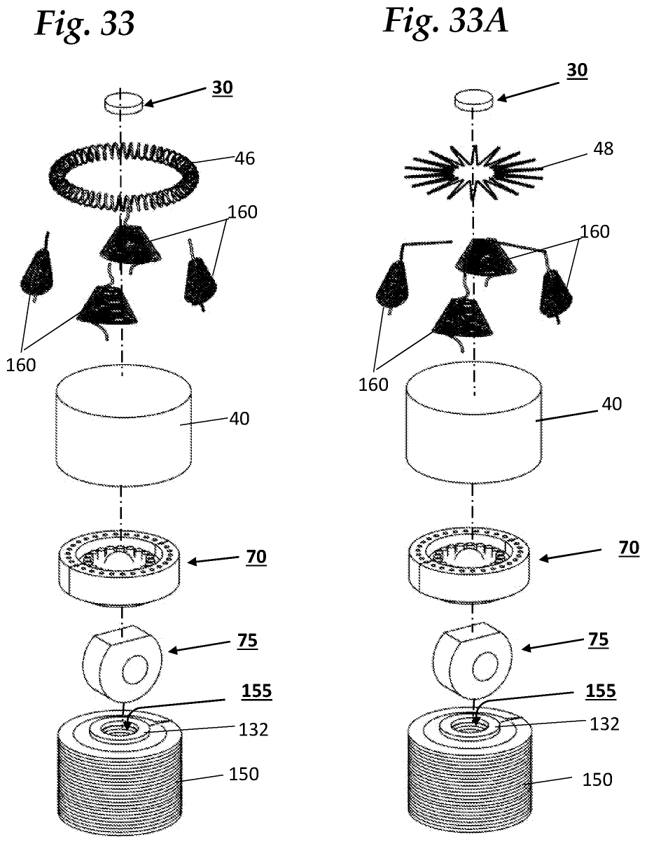

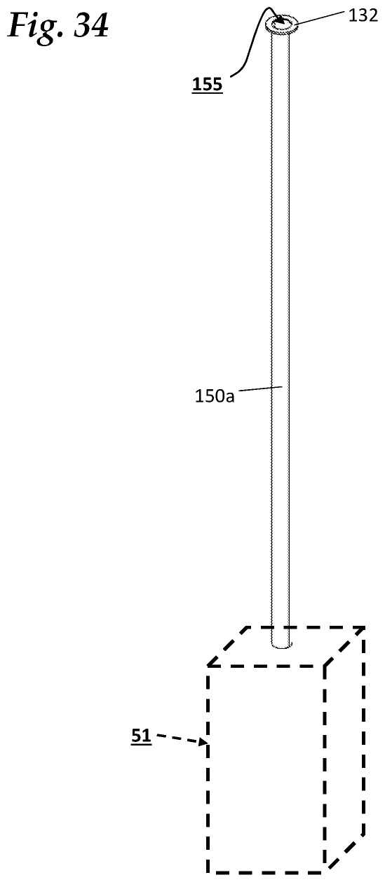

Corrugated boom 150 shown on FIGS. 30 through 34 is itself made from shape-memory material and comprises longitudinal pleats 150 disposed around lumen 155. Boom 150 is stowed in its compressed configuration prior to deployment and assumes extended tubular shape 150a upon application of heat.

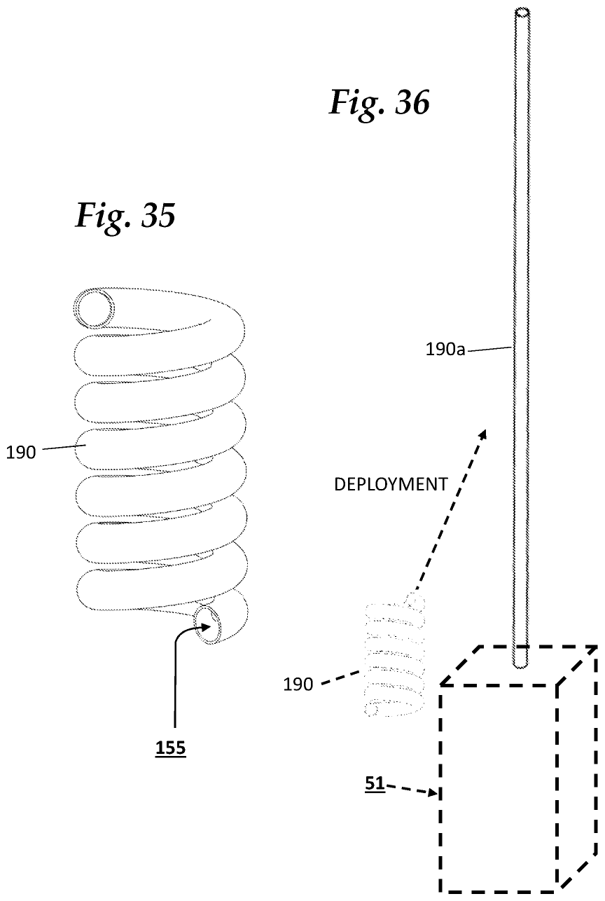

Coiled tubular boom 190 shown on FIGS. 35 and 36 is also made from shape-memory material and is extended/uncoiled to its deployed configuration 190a by application of external heat or by passing electric current directly through it.

A boom can be made to bend or fold to ensure that the field of view of mirror assembly 40a is not obscured by satellite body 51. The bend can be accomplished with a mechanical joint, or the boom can be caused to bend by incorporating a shape memory section into it. With this boom construction, pivot drive 75 will not be required.

Mirror Surface Coating Material Variants Since mirror assembly 88a, 89a operates in high vacuum and low temperature (when not in direct sunlight) of space, numerous materials are feasible for mirror constriction, such as metals and alloys, including low melting temperature ones such as gallium (Ga), cesium (Cs), rubidium (Rb), indium (In), mercury (Hg), tin-based solders and lightweight metals: lithium (Li), sodium (Na), potassium (K), calcium (Ca), aluminum (Al) and their alloys. A very good reflectance performance is achieved by aluminum, silver and gold. Also, as mentioned hereinabove, very high broadband light reflectivities, from deep ultra-violet to visible light wavelengths can be achieved by using metallic potassium (K), especially at low temperatures of space. The cooling/solidification regime for some metals or alloys may have to be adjusted to create an amorphous, glass-like, rather than crystalline, composition and ensure smooth reflecting surface.

Precursor Container Variants

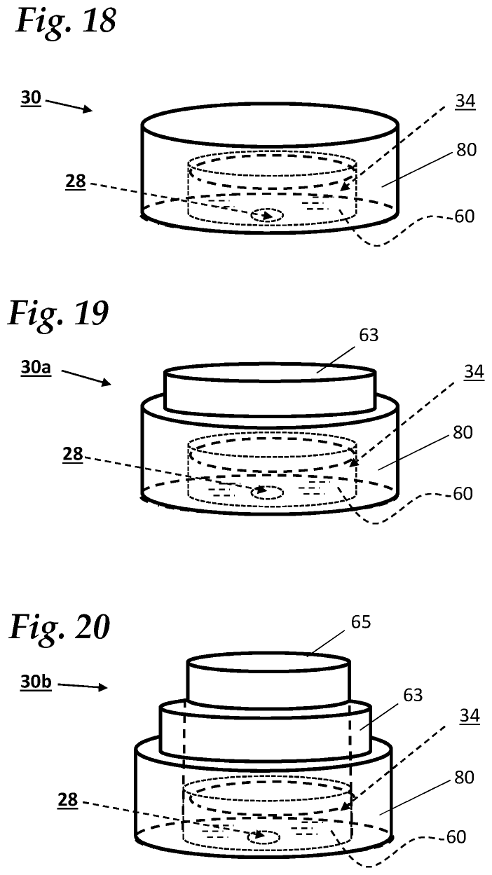

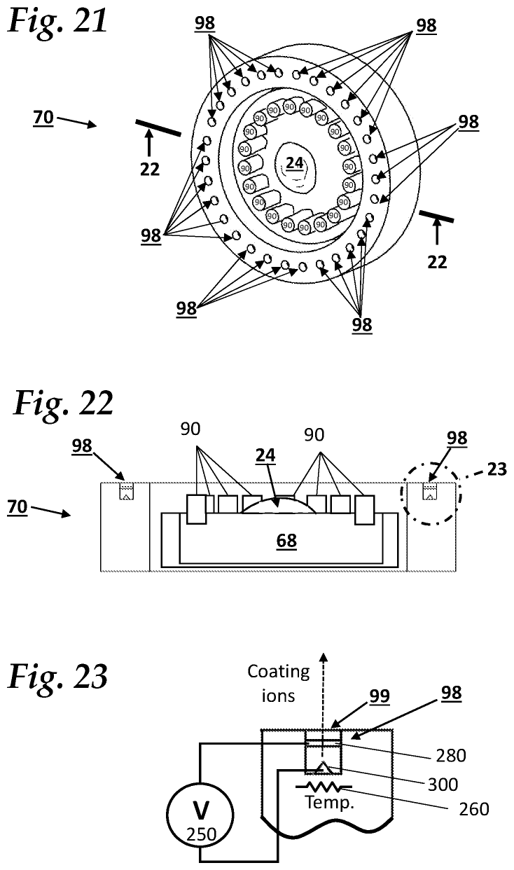

Several variants of container system 30 for the mirror precursor material 60 are presented on FIGS. 18 through 20. Container 30 comprises a case 80 with internal cavity 34 containing liquid precursor material 60. Orifice 28 permits the outflow of material 60 onto deployed mirror support 40a.

Container variant 30a in addition comprises heater 63 to melt material 60. This container can be used with material 60 which would be solid or viscous during launch.

Container variant 30b additionally comprises piston 65 to expel material 60. Piston 65 can be actuated with a pre-compressed spring, a shape-memory type actuator, electrical motor driving a screw-type actuator assembly or an eccentric, compressed gas, or with a pyrotechnic gas generator.

It should be noted that the features of different container variants can be combined, for example, a piston 65 of container 30c can be used with container 30.

Shape Memory Components Heat Pipe Implementations

Struts 160, corrugated boom 150, coiled boom 190, actuators 180 and support hoop 46 or 48, can all be realized as heat pipes rather than solid parts. For example, a heat pipe variant 161 of strut is shown in cross section on FIG. 9 as a hollow member with internal lumen 19b containing wick 19a for transport of vapor and liquid phases of heat pipe working fluid. Actuators 180 can be of similar construction. Utilizing heat pipe technology facilitates fast heating and deployment of shape-memory components since their heating does not rely on a relatively slow heat diffusion phenomenon or direct heating with electric current, but rather employ a heater only on the proximal end of the part.

Strut Variants

Additionally, struts 160 can be formed to transform from cylindrical cross section into a ‘T’—(160b), an ‘I’—(160c) or a ‘Y’—(160d) cross sections upon deployment, as shown on FIG. 11.

Similarly, as shown on FIGS. 12 and 13 strut 160 variants 162 and 163 can have hollow non-cylindrical cross sections with corresponding lumens 27b and 29b, which upon application of heat expand into tubular cross sections 162a and 163a (in addition to un-coiling and extending) with corresponding lumens 27c and 29c. Struts of these cross sections would have different mechanical characteristics, such as directional stiffness, weight, or be particularly suitable for routing signal and/or power cables to image/cure/coat assembly 70.

Additional System Features

While precursor material container assembly 30 is shown located at the center of mirror support 40, it does not have to be located there. The filling of mirror support with precursor 60 or similar can be accomplished from the periphery of support 40. Rotation of satellite 50 or 50a has to be controlled, as was mentioned hereinabove for generation of mirror. Referring to FIG. 15, at first ‘artificial gravity’ is generated by rotation around the Y-axis with angular velocity ω_{Y}. This rotation forces liquid precursor 60 from the periphery of deployed support 40a into its center. While maintaining rotation around the Y-axis, satellite 50 or 50a is then spun around its Z-axis with ω_{Z} angular velocity. The simultaneous rotation in both axes then generates a paraboloid surface in the liquid precursor 60.

Electrical contacts 15 used for direct heating of shape memory components by electric current can be made to disengage from the heated components upon deployment. They can also be made frangible, to also disengage from the components upon their deployment.

Although not shown, satellite 50 or 50a contains articulation means, such as reaction wheels or a propulsion system. Also not shown, solar panels, fixed or deployable, which if present, are preferably deployed after the mirror is created, to simplify satellite control during the mirror creation process.

Although not shown, satellite 50 or 50a may also contain wireless communication means for receiving commands and transmitting acquired images.

In addition, although not shown, satellite 50 or 50a includes various electronics control-, power- and cooling systems necessary for its operation.

While a direct mirror-to-imaging system 24 is disclosed in instant Application, a secondary imaging system can be added as well. Such secondary optical system may comprise a spherical or toroidal convex mirror or a combination of a flat mirror and an imaging lens system. Such systems are well known in their respective art.

Additionally, imaging system 24 can have a shutter to protect it from direct sunlight exposure collected by the mirror.

Mirror pivot drive 75 can be implemented as an electro-mechanical drive or as a shape-memory un-bending or un-coiling element actuated by heat.

Precursor material 60 may have additives or fillers to affect its flowing/filling properties in liquid state, melting or softening temperature, reflectance and/or dimensional stability after solidification. For example, nanosilica additives increase photopolymers post-cure dimensional stability.

Since sun's radiation emission spectrum peaks in the violet, UV-curable precursor photopolymers can be exposed to sunlight for curing, either as a backup to the UV sources, or the precursor primary curing mechanism. This is advantageous for large and very large mirrors for which large and very powerful UV light sources may be unfeasible.

Mirror support 40 may be made reflective on its one or both surfaces to minimize heating by sunlight and minimizing heat-induced stress in the formed mirror. Alternatively, it can have a thermally absorbent coating on its obverse surface, to facilitate melting of solid precursors by the sun.

Dispensing of liquid precursor photopolymers may proceed in several successive stages, to enable curing of a single layer at a time.

Composition of the deposited precursor layers can be made to vary by pre-filling precursors in the precursor container in a particular sequence or by employing several precursor material dispensers in sequence.

For curing of stiffening photopolymer 68 in support 40b LEDs 95 in support hoop 45 can be replaced by an alternate UV source, such as, for instance, a mercury vapor arc lamp, residing inside hoop 45 either ‘as is’ or focused onto support 40b with appropriate optional optical elements, such as cylindrical lens(es).

Alternatively, stiffening of support 40 (after depositing stiffening precursor 60a) or 40b (impregnated with stiffening precursor 68) can be accomplished by exposing it to UV from sunlight.

While the described coating process uses vaporized material deposition, other ways of depositing reflective and protective coatings can be used for the mirror. For example, there exists a well-known material sputtering process. Additionally, chemical metals deposition techniques exist, such as ‘electro-less’ nickel, tin and copper deposition processes.

Stand-Alone Mirror Structures

A stand-alone mirror structure can be made by substituting a satellite body 51 and boom 120 with a counterweight connected to a mirror support by a strut and following the general mirror-generating procedures described above.

The mirror support of this structure can be filled on-orbit with precursor material(s) and then spun by external mechanisms or human operators to generate a paraboloid mirror surface.

Even though the foregoing descriptions concern small, miniature and ‘nano’ satellites, the methods, components and structures described can be readily utilized for conventional as well as large and very large satellites and space-borne mirror structures.

Although descriptions provided above contain many specific details, they should not be construed as limiting the scope of the present invention.

All features disclosed in the specification, including the claims, abstract, and drawings, and all the steps in any method or process disclosed, may be combined in any combination, except combinations where at least some of such features and/or steps are mutually exclusive.

Each feature disclosed in the specification, including the claims, abstract, and drawings can be replaced by alternative features serving the same, equivalent, or similar purpose, unless expressly stated otherwise.

Thus, the scope of this invention should be determined from the appended claims and their legal equivalents.

I claim:

1. An imaging system comprising a body, a mirror support and a paraboloid mirror, said mirror formed in space from liquid precursor material by spinning said imaging system simultaneously around at least two orthogonal axes.

2. The imaging system of claim 1 wherein said mirror is generated from a precursor material selected from the group consisting of:
a) photopolymers,
b) thermoplastic polymers,
c) thermoset polymers,
d) metals and alloys.

3. The imaging system of claim 2 wherein said precursor material is dispensed in a liquid form, subsequently assumes a paraboloid form due to said spinning of said imaging system, and subsequently solidified.

4. The imaging system of claim 3 wherein said precursor material is solidified by cooling.

5. The imaging system of claim 3 wherein said precursor material is solidified by exposure to radiation.

6. The imaging system of claim 1 wherein said mirror further comprises at least one optical coating on its surface, said coating deposited onto said mirror after said mirror has been formed.

7. The imaging system of claim 1 wherein said mirror support comprises pliable material.

8. The pliable material of claim 7 comprising woven material.

9. The woven material of claim 8 further impregnated with stiffening agent.

10. The imaging system of claim 1 further comprising deployable mirror support boom.

11. A imaging system comprising a body, an extendable boom having a proximal end and a distal end, said boom transformable from its stowed configuration into its extended configuration, said boom connected by said proximal end to said imaging system body, said boom at said distal end connected to a mirror pivot mechanism, said pivot mechanism connected to a deployable mirror support, said mirror support transformable from its stowed configuration into its deployed configuration, said mirror support in said deployed configuration assuming a disc shape, said mirror support further comprising mirror precursor container, said precursor container located at the center of said disk, a mirror precursor material stored in said precursor container, said container communicating via an aperture with said mirror support when said support is in said deployed configuration, said precursor transferable into said support via said aperture, said imaging system being capable of spinning simultaneously around a first axis perpendicular to the surface of said disk and passing through the center of said disk, and a second axis perpendicular to said first axis, said second axis passing through the center of mass of a combination of: a) said imaging system, b) said boom in said deployed configuration and c) said mirror support in said deployed configuration, a paraboloid surface formed on said precursor material as a result of said imaging system spinning, said precursor solidified after forming said paraboloid surface.

12. The imaging system of claim 11 wherein said mirror support comprising pliable material.

13. The mirror support of claim 12 capable of being stiffened.

14. The imaging system of claim 11 wherein said boom actuator comprises a helical coil, said coil made of shape memory material, said coil positioned co-axially with said telescopic elements and connected on its proximal end to a proximal end of said outermost telescopic element and on its distal end to a distal end of said innermost telescopic element, said coil prior to deployment comprising a compressed shape, said coil extending lengthwise by being heated to near or above glass transition temperature of said shape memory material and urging said telescopic elements into said deployed configuration of said boom.

15. The imaging system of claim 11 wherein said boom actuator comprises at least one elongated rod, said rod made of shape memory material, said rod folded or coiled in stowed configuration, said rod comprising a proximal end and a distal end, said rod on its said proximal end connected to a proximal end of said outermost telescopic element, said rod on its said distal end connected to a distal end of said innermost telescopic element, said rod straightening from said stowed configuration upon being heated to near or above glass transition temperature of said shape memory material and extending said telescopic feed by pushing said distal end of said innermost element away from said proximal end of said outermost element.

16. The imaging system of claim 11 wherein said boom comprises a hollow cylinder, said boom having a first stowed configuration and a second deployed configuration, said stowed configuration comprising a pleated cylindrical shell, wherein pleats of said shell are oriented perpendicular to the longitudinal axis of said shell, said deployed configuration comprising a smooth cylinder, said boom in said deployed configuration having length greater that said boom in said stowed configuration, said boom made of shape memory material, said boom upon being heated to a temperature near or above its material glass transition temperature transforming from its said stowed configuration to its said deployed configuration.

17. The imaging system of claim 11 wherein said boom comprises a hollow cylinder, said boom having a first stowed configuration and a second deployed configuration, said stowed configuration comprising said hollow cylinder helically coiled, said deployed configuration comprising said hollow cylinder straightened, said boom made of shape memory material, said boom upon being heated to a temperature near or above its material glass transition temperature transforming from its said stowed configuration to its said deployed configuration.

18. The imaging system of claim 11 wherein said precursor material is selected from the group consisting of:
e) photopolymers,
f) thermoplastic polymers,
g) thermoset polymers,
h) metals and alloys.

19. The imaging system of claim 11 further comprising at least one radiation source, said radiation source emitting radiation capable of solidifying said precursor upon exposure.

20. A method of creating a paraboloid mirror system while in space, said system comprising a mirror support and a counterweight, said support and said counterweight being interconnected, and generating a paraboloid mirror surface on said mirror support by the steps of:
a) spinning said mirror system in two orthogonal axes, namely, a first axis parallel to the centerline of said support and passing through the center of said support and a second axis perpendicular to said axis, said second axis intersecting said first axis at center of mass of combined said mirror support and said counterweight,
b) dispensing liquid precursor material into said mirror support,
c) allowing said precursor to attain a paraboloid surface resulting from spinning of said support and said precursor around said first and said second axes,
d) allowing or causing said precursor to solidify with said paraboloid surface.
